(19) United States
(12) Patent Application Publication
(10) Pub. No.: US 2005/0240424 A1
(43) Pub. Date: Oct. 27, 2005

(54) System and method for hierarchical attribute extraction within a call handling system

(76) Inventors: Xiaofan Lin, Sunnyvale, CA (US); Steven John Simske, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/833,444

(22) Filed: Apr. 27, 2004

(51) Int. Cl. G06F 17/60

(52) U.S. Cl. 705/1

(57) ABSTRACT

A system and method for attribute extraction within a call handling system is disclosed. The method discloses: initiating a dialog between a contact and a call handling system; waiting for a first length of the dialog; assigning the contact to a first attribute category by processing the first length of the dialog using a first instance of a first classifier; waiting for a second length of the dialog; and assigning the contact to a second attribute category by processing the second length of the dialog using a first instance of a second classifier trained to categorize dialogs assigned only to the first attribute category. The system discloses means and mediums for practicing the method.

### CROSS-REFERENCE TO RELATED OR CO-PENDING APPLICATIONS

This application relates to co-pending U.S. patent application Ser. No. 10/769240, entitled “System And Method For Language Variation Guided Operator Selection,” filed on Jan. 30, 2004, by Lin et al. This related application is commonly assigned to Hewlett-Packard Development Co. of Houston, Tex.

### BACKGROUND OF THE INVENTION

1. Field of the Invention

The present invention relates generally to systems and methods for call handling, and more particularly to for hierarchical attribute extraction within a call handling system.

2. Discussion of Background Art

Automated call handling systems, such as Interactive Voice Response (IVR) systems, using Automatic Speech Recognition (ASR) and Text-to-speech (TTS) software are increasingly important tools for providing information and services to contacts, such as customers, in a more cost efficient manner. IVR systems are typically hosted by call centers that enable contacts to interact with corporate databases and services over a telephone using a combination of voice speech signals and telephone button presses. IVR systems are particularly cost effective when a large number of contacts require data or services that are very similar in nature, such as banking account checking, ticket reservations, etc., and thus can be handled in an automated manner often providing a substantial cost savings due to a need for fewer human operators.

Automated call handling systems often require knowledge of one or more contact attributes in order to most efficiently and effectively provide service to the contact. Such attributes may include the contact's gender, language, accent, dialect, age, and identity. For example, contact gender information may be needed for adaptive advertisements while the contact's accent information may be needed for possible routing to a customer service representative (i.e. operator).

However, extracting such attributes (i.e. metadata) from the contact's speech signals or textual messages is typically a complex and time consuming process. Current methods involve laboriously examining the contact's speech signals and textual messages in order to try and determine each of the contact's attributes. Such systems tend to be slow and have varying accuracy.

In response to the concerns discussed above, what is needed is a system and method for call handling that overcomes the problems of the prior art.

### SUMMARY OF THE INVENTION

The present invention is a system and method for hierarchical attribute extraction within a call handling system. The method of the present invention includes the elements of: initiating a dialog between a contact and a call handling system; waiting for a first length of the dialog; assigning the contact to a first attribute category by processing the first length of the dialog using a first instance of a first classifier; waiting for a second length of the dialog; and assigning the contact to a second attribute category by processing the second length of the dialog using a first instance of a second classifier trained to categorize dialogs assigned only to the first attribute category. The system of the present invention includes all means and mediums for practicing the method.

These and other aspects of the invention will be recognized by those skilled in the art upon review of the detailed description, drawings, and claims set forth below.

### BRIEF DESCRIPTION OF THE DRAWINGS

FIG. 1 is a dataflow diagram of one embodiment of a system for hierarchical attribute extraction within a call handling system;

FIG. 2 is a Venn diagram of an exemplary set of clustering characteristics;

FIG. 3 is a Venn diagram of an exemplary set of ground-truth training data;

FIG. 4 is a root flowchart of one embodiment of a method for hierarchical attribute extraction within a call handling system; and

FIG. 5 is a flowchart of one embodiment of a method for hierarchical attribute extraction within a call handling system.

### DETAILED DESCRIPTION OF THE PREFERRED EMBODIMENT

The present invention discloses a system and method for hierarchically extracting a set of contact attributes from a contact's speech signals or textual messages, thereby taking advantage of synergies between multiple contact attribute classifications. Such hierarchical extraction improves a call handling system's speed and efficiency since downstream attribute classifiers only need process a sub-portion of the contact's speech signal or textual messages. Speed and efficiency are further improved by varying the length of the speech signal or text message required by a set of classifiers that identify the contact's attributes.

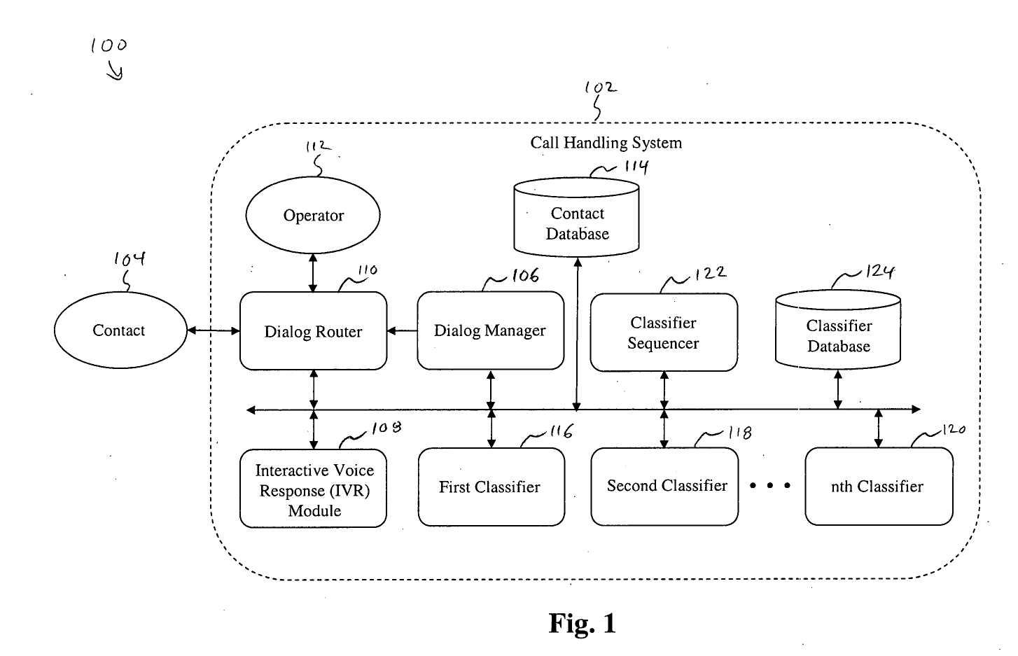

FIG. 1 is a dataflow diagram of one embodiment of a system 100 for hierarchical attribute extraction within a call handling system 102. The call handling system 102 of the present invention preferably provides some type of voice interactive information management service to a set of contacts. Anticipated information services include those associated with customer response centers, enterprise help desks, business generation and marketing functions, competitive intelligence methods, as well as many others. Contacts may be customers, employees, or any party in need of the call center's services.

To begin, a contact 104 enters into a dialog with the call handling system 102. While the dialog typically begins once a dialog manager 106 connects the contact 104 to an Interactive Voice Response (IVR) module 108 through a dialog router 110, alternative dialogs could route the contact 104 directly or eventually to a human operator 112. The IVR module 108 provides an automated interface between the contact's 104 speech signals and the system's 102 overall functionality. To support such an interface with the contact 104, the IVR module 108 may include a Text-To-Speech (TTS) translator, Natural Language Processing (NLP) algorithms, Automated Speech Recognition (ASR), and various other dialog interpretation (e.g. a Voice-XML interpreter) tools. As part of the dialog, the IVR module 108 receives information requests and responses from the contact 104 that are then processed and stored in accordance with the call handling system's 102 functionality in a contact database 114. The system 102 may also receive textual messages from the contact 104 during the dialog.

Indentify Contact Attributes for Classification

The dialog manager 106 retrieves a request to identify a predetermined set of contact attributes with respect to the contact 104. Such requested contact attributes may include the contact's gender, language, accent, dialect, age, or identity, as is dictated by the system's 102 functionality.

The request is preferably stored in memory prior to initiation of the dialog by the contact 104 due to a need to train a set of attribute classifiers on ground-truth data before performing hierarchical attribute extraction. Hierarchical attribute extraction is discussed in more detail below. In an alternate embodiment, the request can be generated in real-time as the system 102 interacts with the contact 104 (i.e. automatically generated as part of the dialog hosted by the IVR module 108 or based on inputs received from the operator 112).

Classifier Selection

A set of classifiers 116, 118, and 120 required to extract the contact attributes from the contact's speech signals and textual messages are selected by the dialog manager 106.

Each of the classifiers 116, 118, and 120 can be labeled either according to the set of categories (i.e. gender, accent, age, etc.) to which the classifier assigns the contact's 104 input data (i.e. speech signals and textual messages), or according to how the classifier operates (i.e. acoustic classifier, keyword classifier, business relevance classifier, and etc.).

Such classifier labels overlap, so that a gender classifier may employ both acoustic and keyword techniques and a keyword classifier may be used for both gender and accent classification. In the present invention, however, the classifiers are preferably labeled and hierarchically sequenced according to the set of categories to which the classifier assigns the contact's 104 input data. Those skilled in the art however will recognize that in alternate embodiments the hierarchical sequencing can be based on classifier operation instead.

Hierarchically Sequence Classifiers

How the classifiers 116, 118, and 120 are finally sequenced depends in part upon a set of characteristics used to evaluate each of the classifiers and in part based on how classifier sequencing affects the overall system 102 performance. The classifiers'116, 118, and 120 individual characteristics and the system's 102 overall performance are estimated using a set of ground-truth data. The ground-truth data preferably includes a statistically significant set of pre-recorded speech signals and text messages authored by a predetermined set of contacts having known attributes (i.e. gender, age, accent, etc.).

The classifier sequencer 122 sends the ground-truth data to each classifier for classification. The classifier sequencer 122 receives a set of classification data-points back from each classifier (e.g. a gender classifier and an accent classifier).

Each portion of the sequencing process is now discussed in more detail.

Classifier Clustering Characteristics

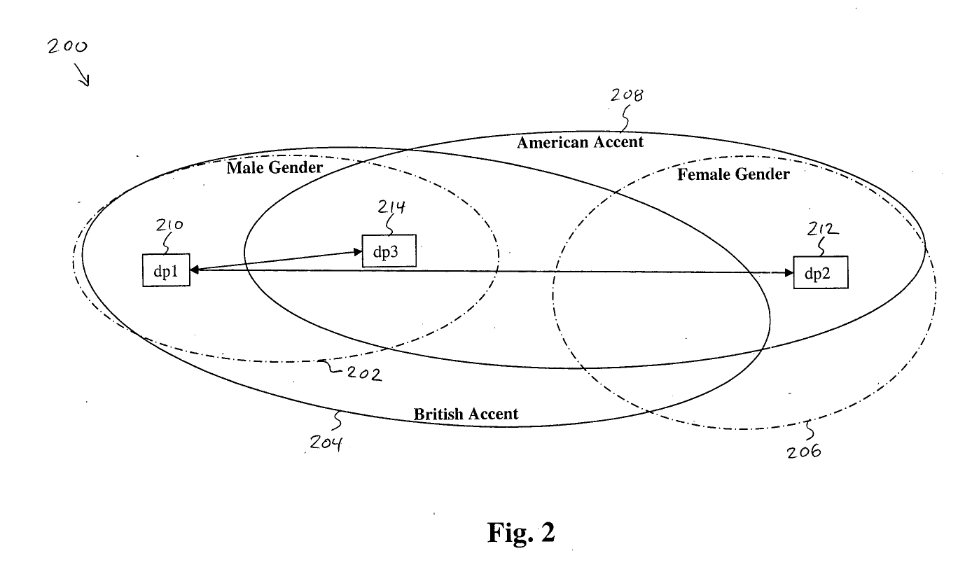

FIG. 2 is a Venn diagram of an exemplary set of clustering characteristics 200 for a set of classifiers that have processed a predetermined set of ground-truth data, and is used to help illustrate the discussion that follows.

The classifier sequencer 122 calculates an “inter-class distance” between all data-points known (via the ground-truth data) to be within a first attribute category (e.g. “Male Gender” 202, or “British Accent” 204) and all data-point known to be within a second attribute category (i.e. “Female Gender” 206, or “American Accent” 208). Those skilled in the art recognize that in other embodiments of the present invention, each classifier may classify the data-points into more that two categories (e.g. “American Accent”, “British Accent”, “Asian Accent”, and so on).

For example, using data-points 210, and 212 shown in FIG. 2, the “inter-class distance” between the “Male Gender” 202 category and the “Female Gender” 206 category would be equal to a distance between dp1 210 and dp2 212. The classifier sequencer 122 averages all of these inter-class distances over the entire set of classification data-points.

The classifier sequencer 122 calculates an “intra-class distance” between all data-points known (via the ground-truth data) to be within a first attribute category (e.g. “Male Gender” 202, “British Accent” 204, “Female Gender” 206, or “American Accent” 208).

For example, using data-points 210, and 214 shown in FIG. 2, the “intra-class distance” for the “Male Gender” 202 category would be equal to a distance between dp1 210 and dp3 214. The classifier sequencer 122 averages all of these intra-class distances over the entire set of classification data-points.

Next, the classifier sequencer 122 defines a clustering characteristic for each classifier based on a ratio between the average “inter-class distance” and average “intra-class distance”. The classifier sequencer 122 sequences the classifiers 116, 118, and 120 based on this ratio. Preferably, the ratio is equal to the average inter-class distance divided by the average intra-class distance, such that those classifiers generating tighter intra-class clusters, as compared to their inter-class clusters will have a higher ratio that those classifiers having looser clustering characteristics.

In the exemplary data of FIG. 2, a gender classifier categorized the data-points into non-overlapping “Male Gender” 202 and “Female Gender” 206 categories, whereas an accent classifier categorized the data-points into very overlapping “British Accent” 204 and “American Accent” 208 categories. In such an example, which has also been observed during a reduction to practice, gender classification is preferably done before accent classification. Those skilled in the art however will know that actual clustering characteristics may vary with each application of the present invention, and the characteristics in FIG. 2 are only for the purposes of illustrating how the present invention operates.

Classifier Accuracy Characteristics

Classifier accuracy characteristics are covariant with yet distinct from classifier clustering characteristics. As such, the accuracy characteristics mostly provide just a different perspective on classifier performance.

Thus, the classifier sequencer 122 calculates an accuracy rate, which is the ratio between a number of the classification data-points that fall within a correct classifier category, according to the ground-truth data, and a total number of the classification data-points.

The classifier sequencer 122 sequences the classifiers 116, 118, and 120 based on this accuracy rate. Preferably, the classifier having a highest accuracy rate is first in the sequence, followed by the less accurate classifiers.

Classifier Saturation Characteristics

The classifier sequencer 122 sends a set of ground-truth data, having a predetermined speech signal or textual length, to each classifier for classification. The classifier sequencer 122 receives a set of classification data-points back from each classifier for each of the predetermined speech signal or textual lengths. The classifier sequencer 122 calculates an accuracy rate, which is the ratio between a number of the classification data-points that fall within a correct classifier category, according to the ground-truth data, and a total number of the classification data-points, for each of the predetermined speech signal or textual lengths.

Then, the classifier sequencer 122 compares the accuracy rate to the predetermined speech signal or textual lengths, resulting in a classifier saturation curve for each classifier. The classifier sequencer 122 sequences the classifiers 116, 118, and 120 according to how quickly each classifier reaches a predetermined point in that classifier's saturation curve. Preferably, the classifier requiring a shortest speech signal or textual lengths to reach the predetermined saturation point is first in the sequence, followed by the slower classifiers.

For example, if gender classification requires only a one second speech signal to accurately classify the contact's 104 gender, whereas accent classification requires about a 30 to 40 second speech signal before accurately classifying the contact's 104 accent, then the classifier sequencer 122 would sequence gender classification before accent classification. Such ordering also permits the system 102 to more quickly use information about the contact's 104 gender during the course of the dialog, while waiting for the contact's 104 accent to be accurately identified. This is analogous to “a short job first” dispatch strategy used in batch job system.

Other Classifier Characteristics

The classifier sequencer 122 can also be programmed to characterize the classifiers 116, 118, and 120 according to many other metrics, including: classifier resource requirements (i.e. computer hardware required to effect the classifier's functionality), and cost (i.e. if a royalty or licensing fee must be paid to effect the classifier). The classifier sequencer 122 can also be programmed to calculate a composite classifier characteristic equal to a weighted sum of a predetermined set of individually calculated classifier characteristics.

The classifier sequencer 122 stores the classifier characterization data in a classifier database 124.

Classifier Sequencing

The classifier sequencer 122 select a sequence for executing each of the classifiers 116, 118, and 120 based on a weighted combination of each of the classifier characteristics. Thus downstream contact attribute classifications only search in a subspace defined by upstream contact attribute classifications. For example, if classifier accuracy is weighted most highly and gender classification has a higher accuracy than accent classification, the dialog manager 106 will effect gender classification on the dialog with the contact 104 first, after which, the dialog manager 106 will effect accent classification using an accent model based on the gender identified for the contact 104, as is discussed in more detail below.

Next, the classifier sequencer 122 further optimizes the sequence for executing each of the classifiers 116, 118, and 120 using a genetic algorithm. Genetic algorithms work by generating a pool of sequences through reproduction (duplicating the old sequence), mutation (random changing part of the old sequence), and crossover (taking parts from two old sequences and forming a new sequence). Before doing reproduction, a metric for each sequence is first evaluated. The better the metric is, the bigger a chance the sequence will participate in the reproduction. In this way, the pool of sequences will be improved generation after generation, so that a best sequence can be selected in a final generation.

Optimize Dialog Length Processed by Each Classifier

The dialog manager 106 selects a dialog length (tₐ, t_{b}, and tₙ, respectively) for each of the classifiers 116, 118, and 120. The dialog length is the length of the dialog between the contact 104 and the system 102 which a classifier is given in order to classify a selected contact 104 attribute. In general, the longer the dialog length used then the higher the classifier's accuracy. However, as discussed above each classifier has a saturation characteristic so that longer dialog lengths yield less proportional improvements in accuracy, so a reasonable tradeoff is made, preferably using a cost function of the form:
C(tₐ, t_{b}, . . . , tₙ)=wₐ*tₐ+w_{b}*t_{b}+ . . . +wₙ*tₙ−(1−Eₐ(tₐ))*(1−E_{b}(t_{b}))* . . . *(1−Eₙ(tₙ)),
where tₐ, t_{b}, and tₙ correspond to the dialog lengths fed to each classifier 116, 118, and 120, wₐ, w_{b}, and wₙ are classifier weights, and Eₐ, E_{b}, and Eₙ are each classifier's respective error probabilities as a function of the dialog lengths.

The weighted summation part (i.e. wₐ*tₐ+w_{b}*t_{b}+ . . . +wₙ*tₙ) reflects a penalty for processing longer utterances, and the last items (i.e. (1−Eₐ(tₐ))*(1−E_{b}(t_{b}))* . . . *(1−Eₙ(tₙ))) calculate a probability that each of the contact attribute classifications are done correctly, which is the product of the error probabilities of the individual classifiers. The weights (i.e. wₐ, w_{b}, and wₙ) can be decided by system 102 requirements. For example, if the system 102 expeditiously requires the contact's 104 gender, the gender classifier's weight should be larger, relative to the other classifier's weights.

The dialog manager 106 selects the dialog lengths for each of the classifiers 116, 118, and 120 using numerical optimization methods that minimize the cost function. For example: first initialize (tₐ, t_{b}, and tₙ) and calculate a first cost C; next modify tₐ by a small amount δ and calculate a second cost C′. If the second cost C′ is smaller than the first cost C′ keep the δ change to tₐ otherwise change tₐ by −δ. If C′ and C are equivalent, keep tₐ unchanged. Modify t_{b} and tₙ in a similar way. Iteratively modify (tₐ, t_{b}, and tₙ) until C can no longer be reduced.

Train Classifiers

Once the classifier sequence is known, the dialog manager 106 hierarchically trains each of the classifiers 116, 118, and 120 using the set of ground-truth data. For example, if gender classification is performed on the contact's 104 dialog before accent classification, then accent classification is trained twice, once on male gender data, and once on female gender data. Also, because downstream classifiers (e.g. accent classification) are only trained on a subset of the ground-truth data, a total training time for all classifiers 116, 118, and 120 is shorter than if such downstream classifiers were trained on the complete set of ground-truth data.

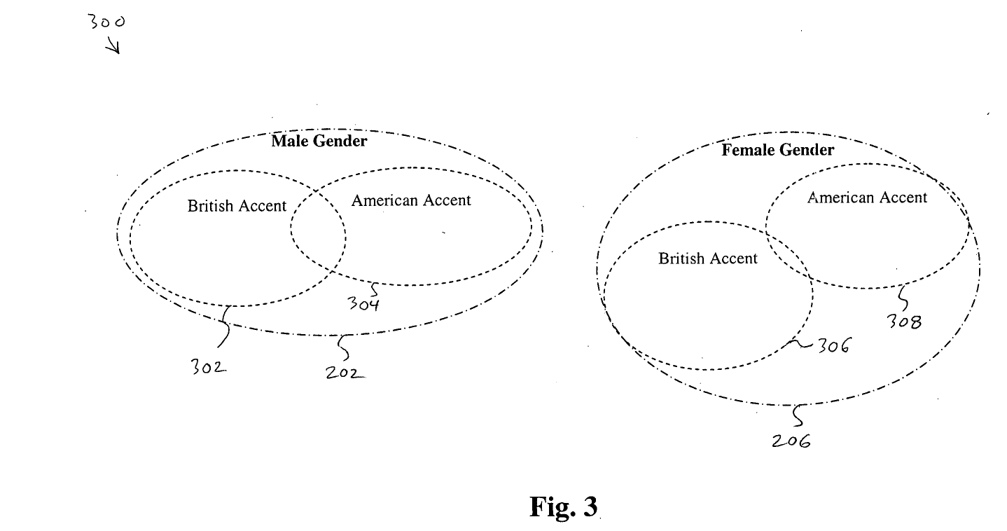

FIG. 3 is a Venn diagram of an exemplary set of ground-truth training data 300. The data 300 includes the “Male Gender” category 202 and the “Female Gender” category 206. The “Male Gender” category 202 includes a “British Accent” category 302 and an “American Accent” category 304. Similarly, the “Female Gender” category 206 includes a “British Accent” category 306 and an “American Accent” category 308. Thus using the example above, gender classification is trained without any prior assumptions on the set of ground-truth data, yielding the “Male Gender” category 202 and the “Female Gender” category 206. However, accent classification is trained on the set of ground-truth data, assuming either the “Male Gender” category 202 and the “Female Gender” category 206. Thus, accent classification is trained twice, once on the “Male Gender” category 202, yielding the “British Accent” category 302 and the “American Accent” category 304, and once on the “Female Gender” category 206, yielding the “British Accent” category 306 and the “American Accent” category 308.

Deploy Classifiers

The dialog manager 106 selects a set of resources to effect dialog classification. Preferably, each instance of the classifiers 116, 118, and 120 operate in parallel on separate computational resources. For example, in the previous example, three parallel sets of computational resources are preferably used: one set for gender detection; one set for male gender accent classification; and one set for female gender accent classification. Such resource specialization, enables each classifier instance to process a large number of classification requests in a given time period.

Those skilled in the art recognize that a variety of resource selections are possible, including effecting all classifiers 116, 118, and 120 on a single computer.

Contact Attribute Extraction From the Dialog

The following discussion assumes that the sequencer 122 hierarchically sequenced the classifiers such that the first classifier 116 is first in the sequence, the second classifier 118 is second in the sequence, and so on through the (n)th classifier 120 that is (n)th in the sequence.

The first classifier 116 waits for a predetermined time for a first length (tₐ) of the dialog. The first classifier 116 (e.g. gender classifier) assigns the contact to a first attribute category (e.g. male gender) by processing the first length of the dialog. The dialog manager 106 transmits the first attribute category to any system 102 applications requiring knowledge of the first attribute category.

A first instance of the second classifier 118 (e.g. an accent classifier trained on male gender ground-truth data only) waits for a predetermined time for a second length (t_{b}) of the dialog. The first instance of the second classifier 118 assigns the contact 104 to a second attribute category (e.g. British Accent) by processing the second length of the dialog. The first instance of the second classifier 118 is trained to categorize dialogs assigned only to the first attribute category (e.g. contacts identified by the first classifier 116 as being of male gender). Preferably, the previous step is performed only if the first attribute category has an error probability less than a predetermined value.

If the first attribute category has an error probability greater than a predetermined value, each other instance of the second classifier 118 (e.g. such as an accent classifier trained on female gender ground-truth data only) assigns the contact 104 to a second attribute category by processing the second length of the dialog. The other instances of the second classifier 118 are individually trained to categorize dialogs assigned to other attribute categories that could have been assigned by the first classifier 116 (e.g. female gender category). The second classifier 118 averages each of the probabilities generated by the other instances of the second classifier 118 yielding a set of combined second attribute category scores. The second classifier 118 assigns to the contact 104 that second attribute category having a highest combined second attribute category score.

The dialog manager 106 transmits the attribute category assigned by the second classifier 118 to any system 102 applications requiring knowledge of that attribute category.

A first instance of the (n)th classifier 120 (e.g. an age classifier trained only on male gender American accent ground-truth data only) waits for a predetermined time for an (n)th length (tₙ) of the dialog. The first instance of the (n)th classifier 120 assigns the contact to an (n)th attribute category (e.g. age attributes) by processing the (n)th length of the dialog. The first instance of the (n)th classifier 120 trained to categorize dialogs assigned only to a predetermined set of attribute categories (e.g. contacts identified by the first classifier 116 as being of male gender, identified by the second classifier 118 as having an American accent, and so on) respectively assigned by the first classifier through an (n-1)th classifier. Preferably, the previous step is performed only if the predetermined set of attribute categories all have error probabilities less than a predetermined set of values.

If, however, one or more of the attribute categories has an error probability greater than its respective predetermined value, then other instances of the (n)th classifier 120 assign the contact 104 to other (n)th attribute categories by processing the (n)th length of the dialog. The other instances of the (n)th classifier 120 are trained to categorize dialogs assigned to other first through (n-1)th attribute categories that could have been assigned by the first through (n-1)th classifiers. The (n)th classifier 120 averages each of the probabilities generated by the other instances of (n)th classifier 120 yielding a set of combined (n)th attribute category scores. The (n)th classifier 120 assigns to the contact 104 that (n)th attribute category having a highest combined (n)th attribute category score.

The dialog manager 106 transmits the (n)th attribute category assigned by the (n)th classifier 120 to any system 102 applications requiring knowledge of that attribute category.

Thus in some instances of the present invention, more than one downstream node can be invoked. For example, the gender classifier may not be very confident about its attribute classification (e.g. a probability of 0.6 as male and 0.4 as female). As a result, both the male and female portions of accent classification are invoked in parallel, and a final accent classification result is a weighted sum of the two individual accent classifications.

These techniques are also applicable to other voice-based sub-classification or sequential classification systems. Temporally-Non-overlapping and Sequential Sub-classification can be applied if there is no overlap in time, and Temporally-Overlapping, Asymptotic-Prediction Limited Parallel Sub-classification can be applied if, multiple sets of computational resources are used, or there are multiple copies of OS on the same machine for in parallel classification (with overlap, but “shutting off” each classifier as it reaches its predicted saturation or accuracy).

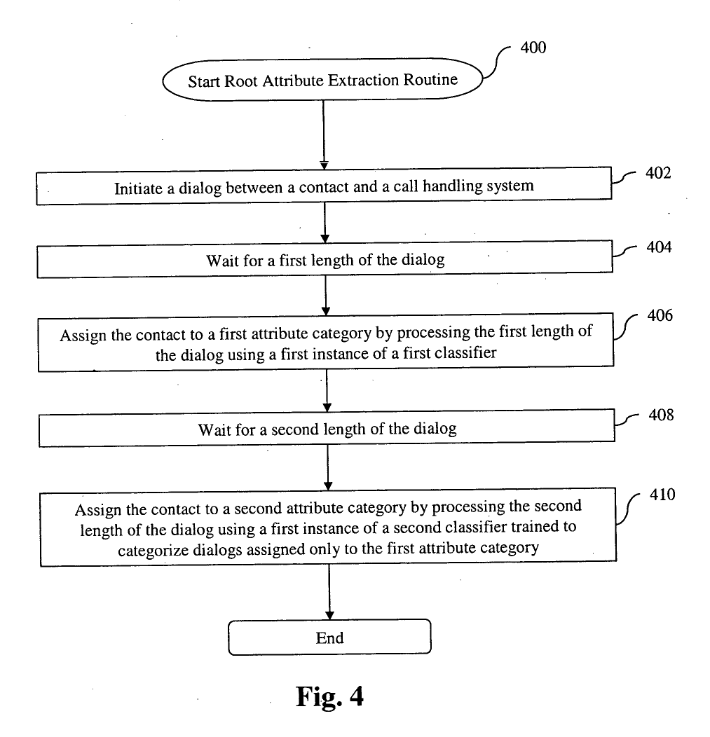

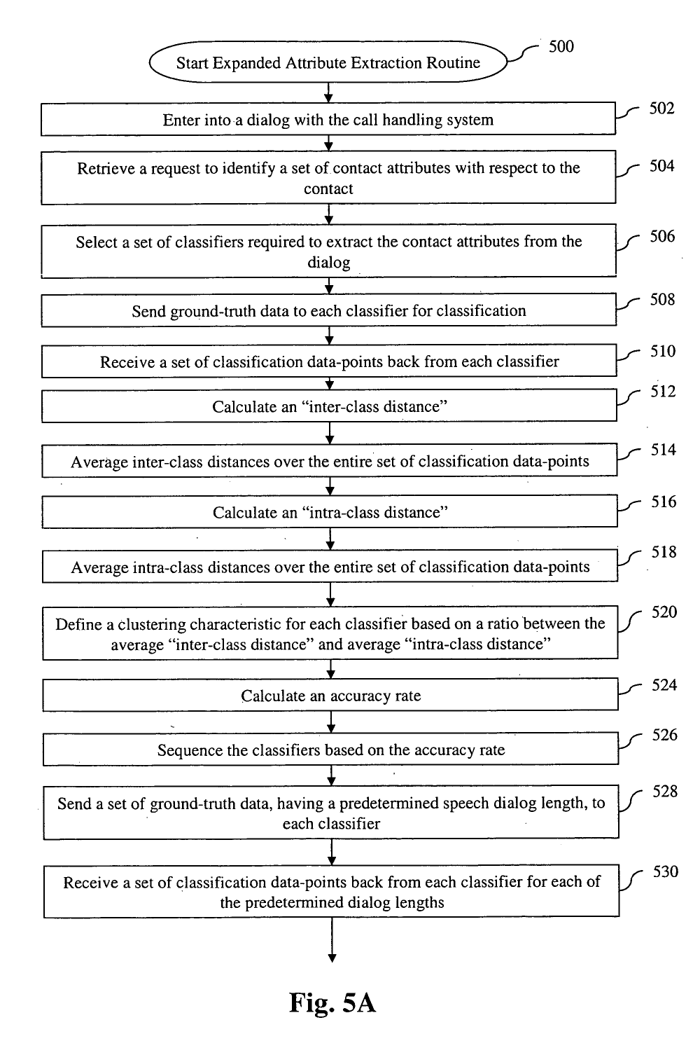

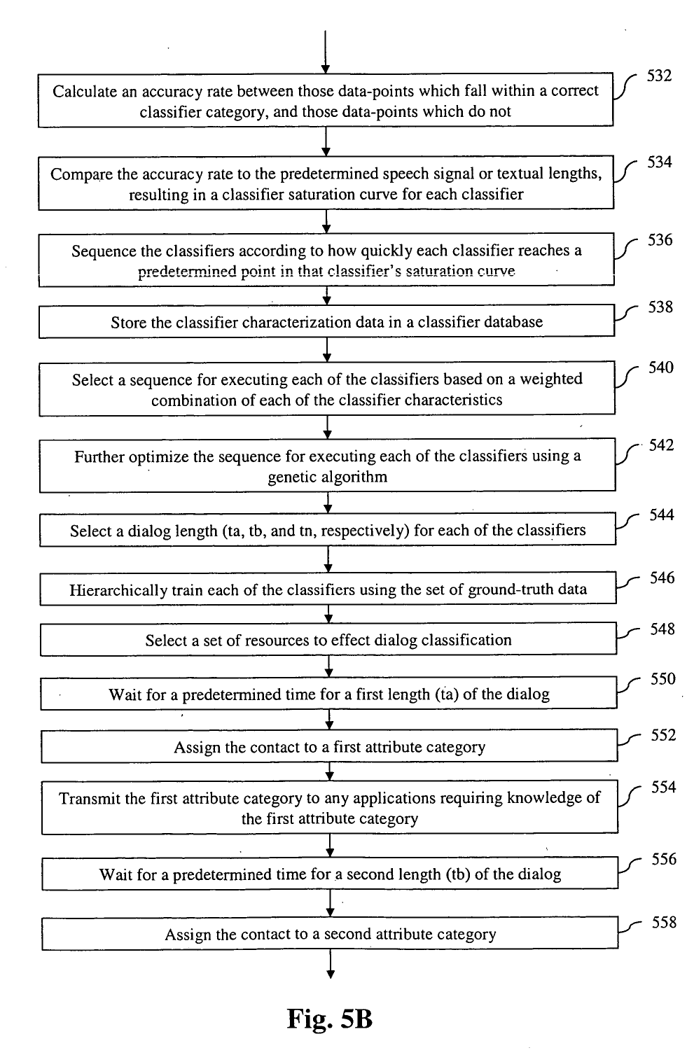

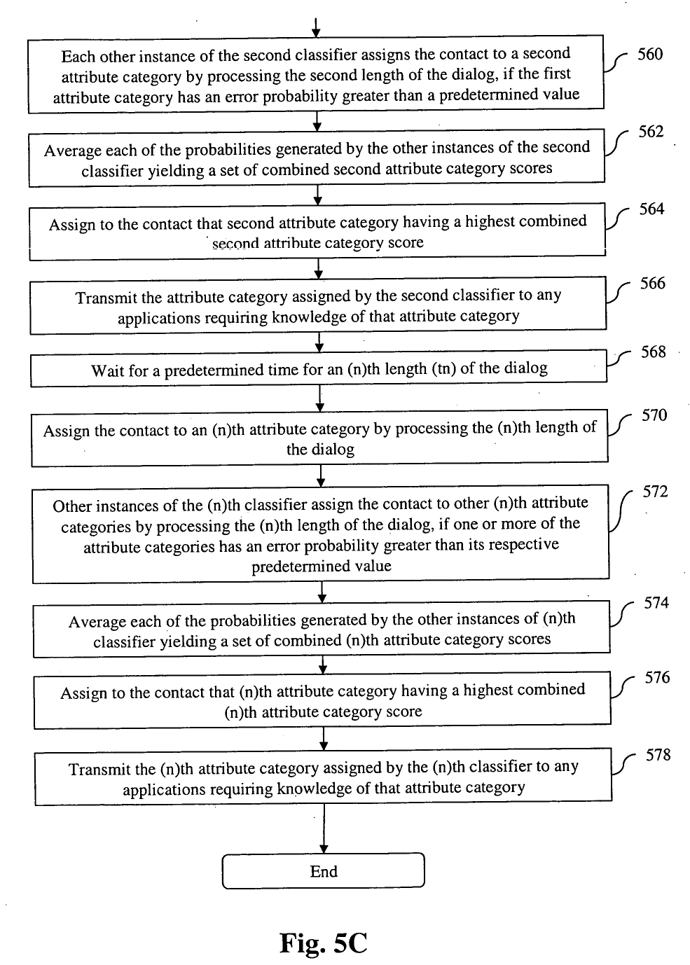

FIG. 4 is a root flowchart of one embodiment of a method 400 for hierarchical attribute extraction within a call handling system. In step 402, a dialog between a contact and a call handling system is initiated. In step 404, a first instance of the first classifier 116 waits for a first length of the dialog. In step 406, the first instance of the first classifier 116 assigns the contact to a first attribute category by processing the first length of the dialog. In step 408, a first instance of the second classifier 118 waits for a second length of the dialog. Then in step 410, the first instance of the second classifier 118 assigns the contact to a second attribute category by processing the second length of the dialog. The first instance of the second classifier 118 is trained to categorize dialogs assigned only to the first attribute category. The root method 400 is discussed in further detail with respect to FIG. 5.

FIG. 5 is a flowchart of one embodiment of a method 500 for hierarchical attribute extraction within a call handling system. To begin, in step 502, a contact 104 enters into a dialog with the call handling system 102.

Identify Contact Attributes for Classification

In step 504, the dialog manager 106 retrieves a request to identify a set of contact attributes with respect to the contact 104.

Classifier Selection

In step 506, a set of classifiers 116, 118, and 120 required to extract the contact attributes from the contact's speech signals and textual messages are selected by the dialog manager 106.

Hierarchically Sequence Classifiers

In step 508, the classifier sequencer 122 sends the ground-truth data to each classifier for classification. In step 5 10, the classifier sequencer 122 receives a set of classification data-points back from each classifier (e.g. a gender classifier and an accent classifier).

Classifier Clustering Characteristics

In step 512, the classifier sequencer 122 calculates an “inter-class distance” between all data-points known (via the ground-truth data) to be within a first attribute category (e.g. “Male Gender” 202, or “British Accent” 204) and all data-point known to be within a second attribute category (i.e. “Female Gender” 206, or “American Accent” 208).

In step 514, the classifier sequencer 122 averages all of these inter-class distances over the entire set of classification data-points. In step 516, the classifier sequencer 122 calculates an “intra-class distance” between all data-points known (via the ground-truth data) to be within a first attribute category (e.g. “Male Gender” 202, “British Accent” 204, “Female Gender” 206, or “American Accent” 208).

In step 518, the classifier sequencer 122 averages all of these intra-class distances over the entire set of classification data-points.

Next in step 520, the classifier sequencer 122 defines a clustering characteristic for each classifier based on a ratio between the average “inter-class distance” and average “intra-class distance”. In step 522, the classifier sequencer 122 sequences the classifiers 116, 118, and 120 based on this ratio.

Classifier Accuracy Characteristics

In step 524, the classifier sequencer 122 calculates an accuracy rate, which is a ratio between a number of the classification data-points that fall within a correct classifier category, according to the ground-truth data, and a total number of the classification data-points.

In step 526, the classifier sequencer 122 sequences the classifiers 116, 118, and 120 based on this accuracy rate.

Classifier Saturation Characteristics

In step 528, the classifier sequencer 122 sends a set of ground-truth data, having a predetermined speech signal or textual length, to each classifier for classification. In step 530, the classifier sequencer 122 receives a set of classification data-points back from each classifier for each of the predetermined speech signal or textual lengths. In step 532, the classifier sequencer 122 calculates an accuracy rate, which is a ratio between a number of the classification data-points that fall within a correct classifier category, according to the ground-truth data, and a total number of the classification data-points, for each of the predetermined speech signal or textual lengths.

Then in step 534, the classifier sequencer 122 compares the accuracy rate to the predetermined speech signal or textual lengths, resulting in a classifier saturation curve for each classifier. In step 536, the classifier sequencer 122 sequences the classifiers 116, 118, and 120 according to how quickly each classifier reaches a predetermined point in that classifier's saturation curve.

Other Classifier Characteristics

Then in step 538, the classifier sequencer 122 stores the classifier characterization data in a classifier database 124.

Classifier Sequencing

In step 540, the classifier sequencer 122 select a sequence for executing each of the classifiers 116, 118, and 120 based on a weighted combination of each of the classifier characteristics. Next in step 542, the classifier sequencer 122 further optimizes the sequence for executing each of the classifiers 116, 118, and 120 using a genetic algorithm.

Optimize Dialog Length Processed by Each Classifier

In step 544, the dialog manager 106 selects a dialog length (tₐ, t_{b}, and tₙ, respectively) for each of the classifiers 116, 118, and 120.

Train Classifiers

Once the classifier sequence is known, the dialog manager 106 hierarchically trains each of the classifiers 116, 118, and 120 using the set of ground-truth data, in step 546.

Deploy Classifiers

In step 548, the dialog manager 106 selects a set of resources to effect dialog classification.

Contact Attribute Extraction From the Dialog

In step 550, the first classifier 116 waits for a predetermined time for a first length (tₐ) of the dialog. In step 552, the first classifier 116 (e.g. gender classifier) assigns the contact to a first attribute category (e.g. male gender) by processing the first length of the dialog. In step 554 the dialog manager 106 transmits the first attribute category to any system 102 applications requiring knowledge of the first attribute category.

In step 556, a first instance of the second classifier 118 (e.g. an accent classifier trained on male gender ground-truth data only) waits for a predetermined time for a second length (t_{b}) of the dialog. In step 558, the first instance of the second classifier 118 assigns the contact 104 to a second attribute category (e.g. British Accent) by processing the second length of the dialog.

In step 560, if the first attribute category has an error probability greater than a predetermined value, each other instance of the second classifier 118 (e.g. including for instance an accent classifier trained on female gender ground-truth data only) assigns the contact 104 to a second attribute category by processing the second length of the dialog.

In step 562, the second classifier 118 averages each of the probabilities generated by the other instances of the second classifier 118 yielding a set of combined second attribute category scores. In step 564, the second classifier 118 assigns to the contact 104 that second attribute category having a highest combined second attribute category score.

In step 566, the dialog manager 106 transmits the attribute category assigned by the second classifier 118 to any system 102 applications requiring knowledge of that attribute category.

In step 568, a first instance of the (n)th classifier 120 (e.g. an age classifier trained only on male gender American accent ground-truth data only) waits for a predetermined time for an (n)th length (tₙ) of the dialog. In step 570, the first instance of the (n)th classifier 120 assigns the contact to an (n)th attribute category (e.g. age attributes) by processing the (n)th length of the dialog.

In step 572, if, however, one or more of the attribute categories has an error probability greater than its respective predetermined value, then other instances of the (n)th classifier 120 assign the contact 104 to other (n)th attribute categories by processing the (n)th length of the dialog.

In step 574, the (n)th classifier 120 averages each of the probabilities generated by the other instances of (n)th classifier 120 yielding a set of combined (n)th attribute category scores. In step 576, the (n)th classifier 120 assigns to the contact 104 that (n)th attribute category having a highest combined (n)th attribute category score.

In step 578, the dialog manager 106 transmits the (n)th attribute category assigned by the (n)th classifier 120 to any system 102 applications requiring knowledge of that attribute category.

While one or more embodiments of the present invention have been described, those skilled in the art will recognize that various modifications may be made. Variations upon and modifications to these embodiments are provided by the present invention, which is limited only by the following claims.

1. A method for hierarchical attribute extraction, comprising:
initiating a dialog between a contact and a call handling system;
waiting for a first length of the dialog;
assigning the contact to a first attribute category by processing the first length of the dialog using a first instance of a first classifier;
waiting for a second length of the dialog; and
assigning the contact to a second attribute category by processing the second length of the dialog using a first instance of a second classifier trained to categorize dialogs assigned only to the first attribute category.

2. The method of claim 1, wherein:
the first attribute category is a gender category; and
the second attribute category is an accent category.

3. The method of claim 1, further comprising:
transmitting the first attribute category to an application hosted by the call handling system before assigning the second attribute category.

4. The method of claim 1, further comprising:
processing the second length of the dialog using other instances of the second classifier trained to categorize dialogs assigned to other attribute categories that could have been assigned by the first classifier, if the first attribute category has an error probability greater than a predetermined value;
averaging a set of probabilities generated by each instance of the second classifier yielding a set of combined second attribute category scores; and
assigning the contact to that second attribute category having a highest combined second attribute category score.

5. The method of claim 1, further comprising:
waiting for an (n)th length of the dialog; and
assigning the contact to an (n)th attribute category by processing the (n)th length of the dialog using an (n)th classifier trained to categorize dialogs assigned only to a predetermined set of attribute categories respectively assigned by the first through (n-1)th classifiers.

6. The method of claim 5, further comprising:
processing the (n)th length of the dialog using other (n)th classifiers trained to categorize dialogs assigned to either the predetermined set of attribute categories or another set of attribute categories that could have been assigned by the first through (n-1)th classifiers, if one of the attribute categories has an error probability greater than a predetermined value;
averaging a set of probabilities generated by each instance of (n)th classifier yielding a set of combined (n)th attribute category scores; and
assigning the contact to that (n)th attribute category having a highest combined (n)th attribute category score.

7. The method of claim 1, wherein:
the dialog includes textual messages.

8. The method of claim 1, further comprising:
selecting the first classifier and the second classifier based on a weighted combination of each classifier's characteristics.

9. The method of claim 8, further comprising:
generating a set of attribute category data-points using a classifier;
defining an inter-class distance as a distance between a first data-point within an attribute category and a second data-point within another attribute category;
defining an intra-class distance as a distance between the first data-point and a third data-point within the attribute category;
comparing the inter-class distance with the intra-class distance; and
assigning a clustering characteristic to the classifier based on the comparison.

10. The method of claim 8, further comprising:
generating a set of attribute category data-points using a classifier;
comparing a number of the data-points that fall within a correct contact attribute category to a total number of data-points within the set of attribute category data-points; and
assigning an accuracy characteristic to the classifier based on the comparison.

11. The method of claim 8, further comprising:
generating a first error probability from a classifier that processes a first pre-set dialog length;
generating a second error probability from the classifier that processes a second pre-set dialog length;
comparing the first and second error probabilities; and
assigning a saturation characteristic to the classifier based on the comparison.

12. The method of claim 8, further comprising:
assigning a resource requirement characteristic to each classifier.

13. The method of claim 8, further comprising:
assigning a cost characteristic to each classifier.

14. A computer-usable medium embodying program code for commanding a computer to effect hierarchical attribute extraction, comprising:
initiating a dialog between a contact and a call handling system;
waiting for a first length of the dialog;
assigning the contact to a first attribute category by processing the first length of the dialog using a first instance of a first classifier;
waiting for a second length of the dialog; and
assigning the contact to a second attribute category by processing the second length of the dialog using a first instance of a second classifier trained to categorize dialogs assigned only to the first attribute category.

15. The medium of claim 14, further comprising:
processing the second length of the dialog using other instances of the second classifier trained to categorize dialogs assigned to other attribute categories that could have been assigned by the first classifier, if the first attribute category has an error probability greater than a predetermined value;
averaging a set of probabilities generated by each instance of the second classifier yielding a set of combined second attribute category scores; and
assigning the contact to that second attribute category having a highest combined second attribute category score.

16. The medium of claim 14, further comprising:
waiting for an (n)th length of the dialog; and
assigning the contact to an (n)th attribute category by processing the (n)th length of the dialog using an (n)th classifier trained to categorize dialogs assigned only to a predetermined set of attribute catergories respectively assigned by the first through (n-1)th classifiers.

17. The medium of claim 16, further comprising:
processing the (n)th length of the dialog using other (n)th classifiers trained to categorize dialogs assigned to either the predetermined set of attribute categories or another set of attribute categories that could have been assigned by the first through (n-1)th classifiers, if one of the attribute categories has an error probability greater than a predetermined value;
averaging a set of probabilities generated by each instance of (n)th classifier yielding a set of combined (n)th attribute category scores; and
assigning the contact to that (n)th attribute category having a highest combined (n)th attribute category score.

18. A system for hierarchical attribute extraction, comprising a:
means for initiating a dialog between a contact and a call handling system;
means for waiting for a first length of the dialog;
means for assigning the contact to a first attribute category by processing the first length of the dialog using a first instance of a first classifier;
means for waiting for a second length of the dialog; and
means for assigning the contact to a second attribute category by processing the second length of the dialog using a first instance of a second classifier trained to categorize dialogs assigned only to the first attribute category.

19. The system of claim 18, further comprising:
means for processing the second length of the dialog using other instances of the second classifier trained to categorize dialogs assigned to other attribute categories that could have been assigned by the first classifier, if the first attribute category has an error probability greater than a predetermined value;
means for averaging a set of probabilities generated by each instance of the second classifier yielding a set of combined second attribute category scores; and
means for assigning the contact to that second attribute category having a highest combined second attribute category score.

20. The system of claim 18, further comprising:
means for selecting the first classifier and the second classifier based on a weighted combination of each classifier's characteristics.
